(19) United States
(12) Patent Application Publication
(10) Pub. No.: US 2011/0090779 A1
(43) Pub. Date: Apr. 21, 2011

(54) APPARATUS FOR GENERATING VITERBI-PROCESSED DATA

(75) Inventors: Chih-Ching Yu, Hsinchu City (TW); Yu-Hsuan Lin, Taichung City (TW); Pi-Hai Liu, Hsinchu County (TW)

(73) Assignee: MEDIATEK INC., Hsin-Chu (TW)

(21) Appl. No.: 12/703,874

(22) Filed: Feb. 11, 2010

Related U.S. Application Data
(60) Provisional application No. 61/252,174, filed on Oct. 16, 2009.

(51) Int. Cl. G11B 20/10

(52) U.S. Cl. 369/59.1; G9B/20.009

(57) ABSTRACT

The invention discloses an apparatus for generating a Viterbi-processed data using an input signal obtained from an optical disk, including a Viterbi module and a binary signal enhancing module. The Viterbi module is configured to process the input signal according to a binary signal. The binary signal enhancing module is configured to boost the input signal and generate the binary signal accordingly.

### CROSS REFERENCE TO RELATED APPLICATIONS

This application claims the benefit of U.S. Provisional Application No. 61/252,174, filed Oct. 16, 2009, the entirety of which is/are incorporated by reference herein.

### BACKGROUND OF THE INVENTION

1. Field of the Invention

The invention relates generally to an apparatus for generating a Viterbi-processed data, and more particularly, to an apparatus for generating a Viterbi-processed data using an input signal obtained from an optical disk.

2. Description of the Related Art

As the continuous development of computer hardware, the optical storage devices have become the mainstream for data preserving, such as DVD and Blue-ray disks. When an optical disk is retrieved, a radio-frequency (RF) signal is obtained. However, the RF signal reproduced from the optical disk may be corrupted due to a scratch on the optical disk or dirt attached thereon. As a result, the RF signal will be decoded using erroneous target levels, leading to a poor decoding result with low data accuracy.

### BRIEF SUMMARY OF THE INVENTION

In light of the above problem, there exists a need to correct the corrupted RF signal, thereby preventing the Viterbi decoder from decoding the RF signal using erroneous target levels.

An embodiment of the invention discloses an apparatus for generating a Viterbi-processed data using an input signal obtained from an optical disk, comprising a Viterbi module, and a binary signal enhancing module. The Viterbi module is configured to process the input signal according to a binary signal. The binary signal enhancing module is configured to boost the input signal and generate the binary signal accordingly.

Another embodiment of the invention discloses an apparatus for generating a Viterbi-processed data using an input signal obtained from an optical disk, comprising a first Viterbi module, a second Viterbi module and a binary signal enhancing module. The first Viterbi module is configured to process the input signal according to a processed signal. The second Viterbi module is coupled to the first Viterbi module and outputs the processed signal by processing the input signal according to a binary signal. The binary signal enhancing module is coupled to the second Viterbi module and generates the binary signal according to the input signal.

Another embodiment of the invention discloses a method for generating a Viterbi-processed data using an input signal obtained from an optical disk, comprising the steps of boosting the input signal to output a boosted input signal, generating a binary signal by detecting the boosted input signal and processing the input signal by a Viterbi module according to the binary signal.

Another embodiment of the invention discloses an apparatus for generating a Viterbi-processed data using an input signal obtained from an optical disk, comprising a Viterbi module, a signal booster and a binary signal enhancing module. The Viterbi module is configured to process the input signal according to a first binary signal. The binary signal enhancing module is configured to generate a second binary signal according to the input signal, boost the input signal, generate a third binary signal according to the boosted input signal, and generate the binary signal according to a signal difference between the second binary signal and the third binary signal.

### BRIEF DESCRIPTION OF THE DRAWINGS

The invention can be more fully understood by reading the subsequent detailed description and examples with references made to the accompanying drawings, wherein:

FIG. 1 depicts a diagram of an optical disk system;

FIG. 2 depicts an apparatus for generating a Viterbi-processed data according to an embodiment of the invention;

FIG. 3 depicts a flowchart of a method for generating a Viterbi-processed data using an input signal obtained from an optical disk, which is performed in accordance with the apparatus of FIG. 2;

FIG. 4 depicts an apparatus for generating a Viterbi-processed data according to another embodiment of the invention;

FIG. 5 depicts a flowchart of a method for generating a Viterbi-processed data using an input signal obtained from an optical disk, which is performed in accordance with the apparatus of FIG. 4;

FIG. 6 depicts an apparatus for generating a Viterbi-processed data according to another embodiment of the invention;

FIG. 7 depicts a flowchart of a method for generating a Viterbi-processed data using an input signal obtained from an optical disk, which is performed in accordance with the apparatus of FIG. 6;

FIG. 8 depicts an apparatus for generating a Viterbi-processed data according to another embodiment of the invention;

FIG. 9 depicts a block diagram of a binary detection unit according to an embodiment of the invention;

FIG. 10 depicts signal waveforms produced by a binary detection unit according to an embodiment of the invention;

FIG. 11 depicts a flowchart of a method for generating a Viterbi-processed data using an input signal obtained from an optical disk, which is performed in accordance with the apparatus of FIGS. 8 and 9; and

FIG. 12 depicts a detailed diagram of a level adjustor dynamically adjusting the target levels of a Viterbi decoder according to an embodiment of invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

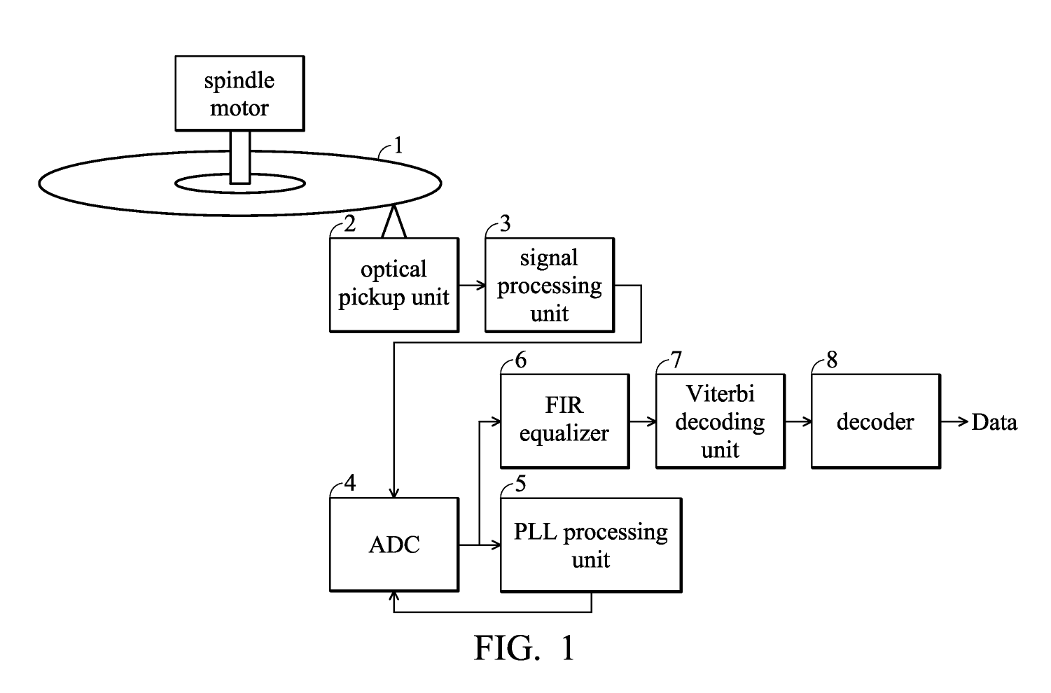

FIG. 1 depicts a diagram of an optical disk system. In FIG. 1, the optical pickup unit 2 retrieves a radio frequency (RF) signal from an optical disk 1. The retrieved RF signal is then sent to a signal processing unit 3 for further processing. The signal processing unit 3 is configured to process the analog RF signal to generate a processed signal which has a higher signal quality. The signal processing unit 3 may comprise a high pass filter for signal processing. The processed signal is provided to an analog-to-digital converting unit (ADC) 4 to be digitalized into a digital signal. The ADC 4 may comprise a sampling circuit for analog-to-digital conversion. In some embodiments, the digital signal is sent to a phase loop lock (PLL) processing unit 5 and a finite impulse response (FIR) equalizer 6, wherein the PLL processing unit 5 is used to maintain or create a clock for the optical disk system. The FIR equalizer 6 performs an equalization operation of the digital signal and outputs an equalized signal to a Viterbi decoding unit 7 for data processing, in which the equalized signal comprises a level suitable to be used by the Viterbi decoding unit 7. The Viterbi decoding unit 7 performs a partial response most likelihood (PRML) procedure on the received signal and outputs a Viterbi-processed data. The Viterbi-processed data is then further processed by a decoder 8 to output a final data, in which the final data is generated by the decoder 8 demodulating the Viterbi-processed data. For example, Viterbi-processed data can be regarded as a Viterbi-decoded data.

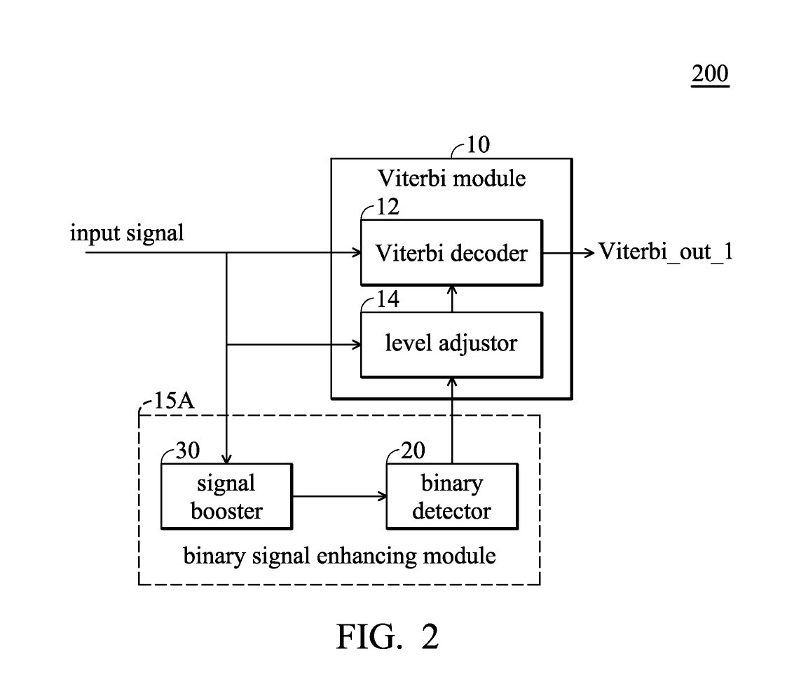

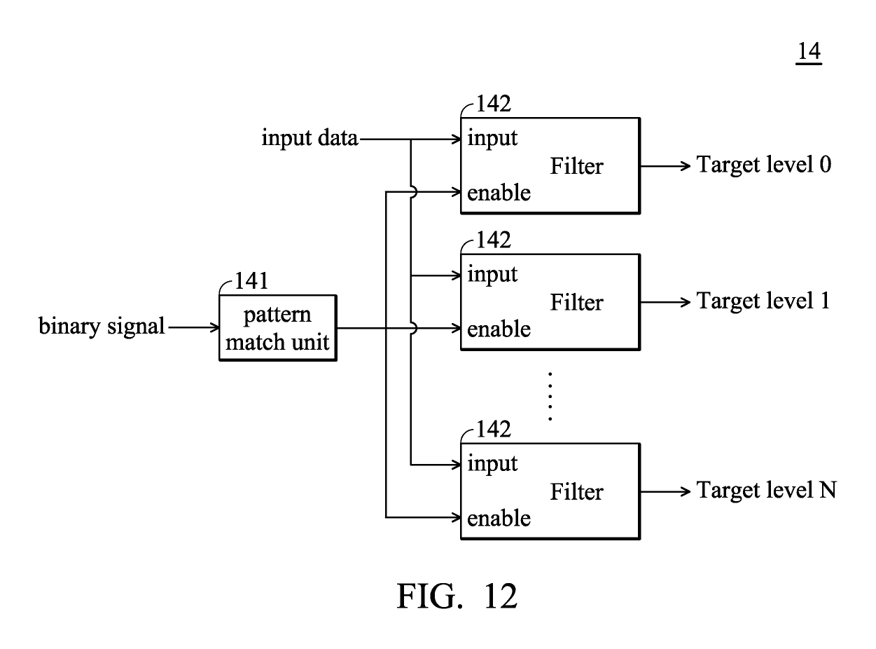

FIG. 2 depicts an apparatus for generating a Viterbi-processed data according to an embodiment of the invention. The apparatus 200 comprises a Viterbi module 10, and a binary signal enhancing module 15A, in which the binary signal enhancing module 15A in this embodiment comprises a binary detector 20 and a signal booster 30. The Viterbi module 10 further comprises a Viterbi decoder 12 and a level adjustor 14. In FIG. 2, the input signal may be an equalized signal outputted by the equalizer 6 (shown in FIG. 1) equalizing an RF signal reproduced from the optical disk 1, but is not limited thereto. The input signal is sent to the binary signal enhancing module 15A for signal boosting and generating a binary signal. Specifically, the input signal is sent to the signal booster 30 for signal boosting. The signal booster 30 boosts the input signal and outputs a boosted input signal to the binary detector 20. The binary detector 20 generates the binary signal for the level adjustor 14 based on the boosted input signal, wherein the binary detector 20 can be, for example, a slicer for slicing the boosted input signal to generate the binary signal for the level adjustor 14. Based on the binary signal and the input signal, the level adjustor 14 dynamically adjusts the target levels of the Viterbi decoder 12 such that the Viterbi decoder 12 processes the input signal using the adjusted target levels and outputs a Viterbi-processed data (signal) Viterbi_out_1. The detailed procedures for adjusting the target levels will be later described in FIG. 12. Note the Viterbi module 10 processing the input signal may refer to the decoding of the input signal, it means that the Viterbi-processed data signal Viterbi_out_1 feedbacks to the level adjustor 14 in some embodiments, but is not limited thereto.

Generally, the binary detector 20 cannot precisely detect the signal with higher frequency, and thus embodiments of the invention utilize the signal booster 30 to boost the (part of) signal with higher frequency (i.e., when the input signal has high frequency part) for the binary detector 20 to be further processed. For example, the signal booster 30 can be implemented by a FIR filter or a high pass filter to obtain such advantage.

As stated above, the RF signal reproduced by the optical pickup unit 2 may be corrupted or weaker due to a scratch on the optical disk 1 or dirt attached thereon. In this case, the signal booster 30 may be used to boost the weaker signal in a proper ration, and enabling the binary detector 20 to easily perform the detecting operation using boosted signal.

When a disc has some defects (i.e., scratches) thereon, signals reflected from the defects would be weaker than normal reflected signals. The embodiment of the invention utilizes signal booster 30 to boost the weaker signal such that the binary detector 20 can detect the received signal thereof.

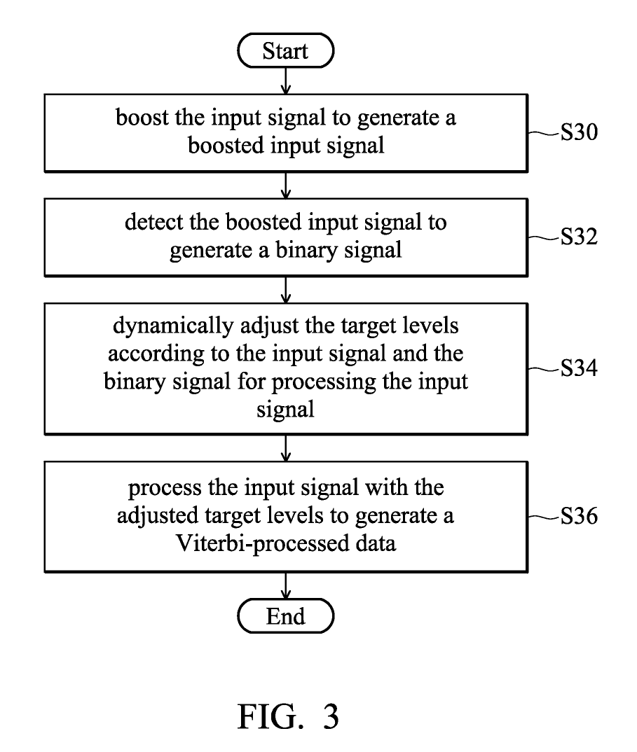

FIG. 3 depicts a flowchart of a method for generating a Viterbi-processed data using an input signal obtained from an optical disk, which is performed in accordance with the apparatus of FIG. 2. At the beginning, the input signal is boosted to generate a boosted input signal (step S30). Next, the boosted input signal is detected to generate a binary signal (step S32). Next, the target levels for processing the input signal are dynamically adjusted according to the input signal and the binary signal (step S34). Next, the input signal is processed with the adjusted target levels to generate a Viterbi-processed data (step S36).

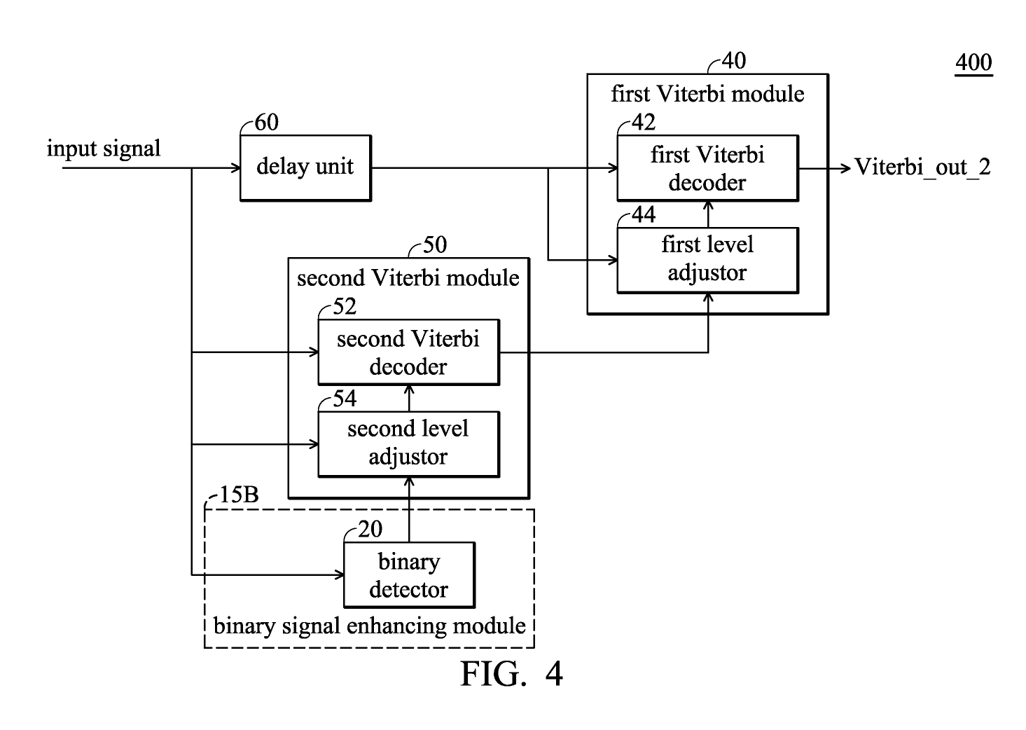

FIG. 4 depicts an apparatus for generating a Viterbi-processed data according to another embodiment of the invention. The apparatus 400 comprises a first Viterbi module 40, a second Viterbi module 50, a delay unit 60 and a binary signal enhancing module 15B, in which the binary signal enhancing module 15B in this embodiment can be implemented by a binary detector 20. The first Viterbi module 40 further comprises a first Viterbi decoder 42 and a first level adjustor 44. The second Viterbi module 50 further comprises a second Viterbi decoder 52 and a second level adjustor 54. The binary signal enhancing module 15B generates a binary signal according to the input signal. In this embodiment, the input signal is sent to the binary detector 20. The binary detector 20 detects the input signal and generates the binary signal for the second level adjustor 54. Based on the binary signal and the input signal, the second level adjustor 54 dynamically adjusts the target levels of the second Viterbi decoder 52 such that the second Viterbi decoder 52 processes the input signal using the adjusted target levels and outputs a processed signal for the first level adjustor 44. At the same time, the input signal is delayed by the delay unit 60 to generate a delayed input signal. The first level adjustor 44, based on the delayed input signal and the processed signal, dynamically adjusts the target levels of the first Viterbi decoder 42. With the target levels dynamically adjusted by the first level adjustor 44, the first Viterbi decoder 42 processes the delayed input signal and outputs a Viterbi-processed data Viterbi_out_2. Same as the description of FIG. 2, the second Viterbi module 50 processing the input signal may refer to the decoding of the input signal, but is not limited thereto. Similarly, the first Viterbi module 40 processing the delayed input signal may refer to the decoding of the delayed input signal, but is not limited thereto.

In contrast to the previous embodiment of FIG. 2, the second Viterbi module 50 in this embodiment can be probably seen as the binary detector 20 of the apparatus 200, but with better performance.

In FIG. 4, the apparatus 400 comprises the first and second Viterbi module 40 and 50, and in terms of the first Viterbi module 40, the second Viterbi module 50 can be regarded as a device with detection (or slicing) function which is more accurate than that of a binary detector (or slicer).

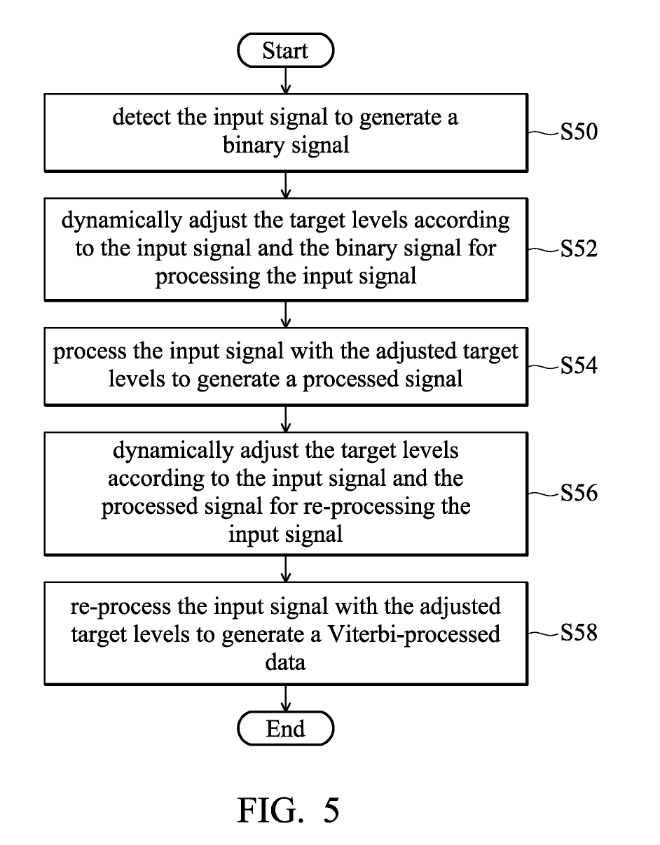

FIG. 5 depicts a flowchart of a method for generating a Viterbi-processed data using an input signal obtained from an optical disk, which is performed in accordance with the apparatus of FIG. 4. At the beginning, the input signal is detected to generate a binary signal (step S50). Next, the target levels for processing the input signal are dynamically adjusted according to the input signal and the binary signal (step S52). Next, the input signal is processed with the adjusted target levels to generate a processed signal (step S54). Next, the target levels for re-processing the delayed input signal are dynamically adjusted according to the input signal and the processed signal (step S56). Next, the input signal is re-processed with the adjusted target levels obtained in step S56 to generate a Viterbi-processed data (step S58).

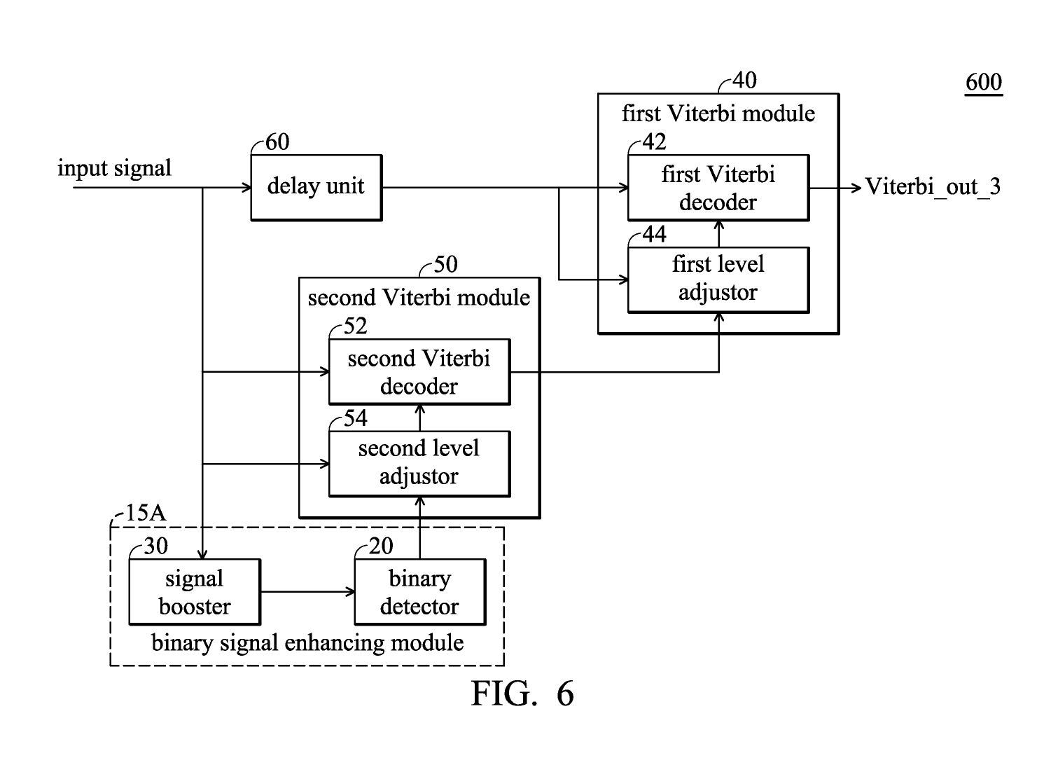

FIG. 6 depicts an apparatus for generating a Viterbi-processed data according to another embodiment of the invention. The apparatus 600 comprises a binary signal enhancing module 15A, a first Viterbi module 40, a second Viterbi module 50 and a delay unit 60, in which the binary signal enhancing module 15A can be implemented by a binary detector 20 and a signal booster 30. The first Viterbi module 40 further comprises a first Viterbi decoder 42 and a first level adjustor 44. The second Viterbi module 50 further comprises a second Viterbi decoder 52 and a second level adjustor 54. In this embodiment, the input signal is sent to the binary signal enhancing module 15A for signal boosting and generating a binary signal according to the boosted signal. Specifically, the input signal is sent to the signal booster 30. The signal booster 30 boosts the input signal and generates a boosted input signal for the binary detector 20. The binary detector 20 detects the boosted input signal and generates the binary signal for the second level adjustor 54. Based on the binary signal and the input signal, the second level adjustor 54 dynamically adjusts the target levels of the second Viterbi decoder 52 such that the second Viterbi decoder 52 processes the input signal using the adjusted target levels and outputs a processed signal for the first level adjustor 44. At the same time, the input signal is delayed by the delay unit 60 to generate a delayed input signal. The first level adjustor 44, based on the delayed input signal and the processed signal, dynamically adjusts the target levels of the first Viterbi decoder 42. With the target levels dynamically adjusted by the first level adjustor 44, the first Viterbi decoder 42 processes the delayed input signal and outputs a Viterbi-processed data Viterbi_out_3. Same as the description above, the second Viterbi module 50 processing the input signal may refer to the decoding of the input signal, but is not limited thereto. Similarly, the first Viterbi module 40 processing the delayed input signal may refer to the decoding of the delayed input signal, but is not limited thereto.

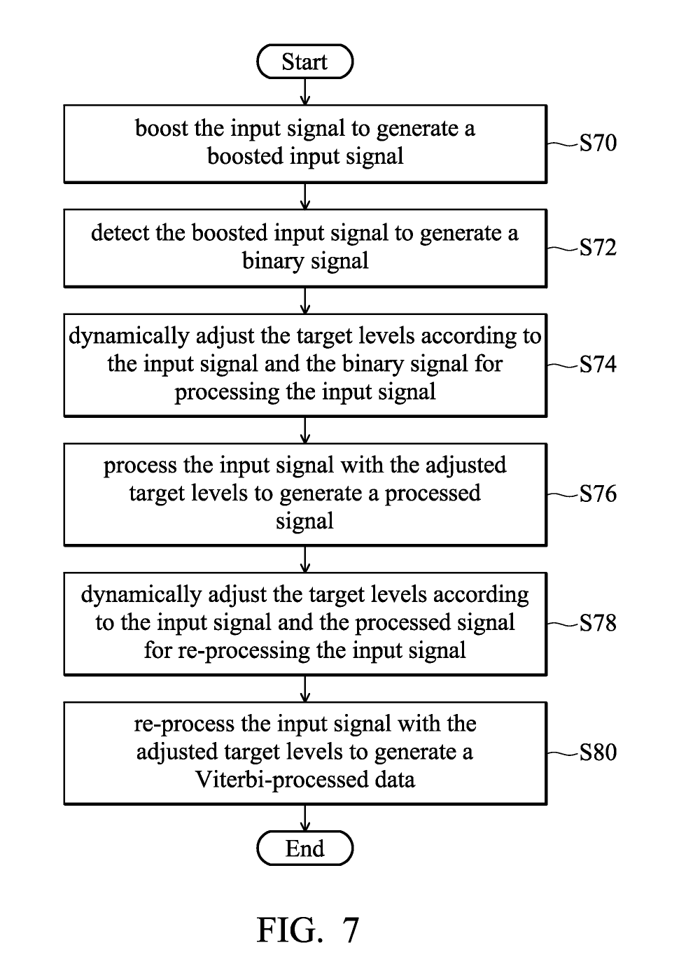

FIG. 7 depicts a flowchart of a method for generating a Viterbi-processed data using an input signal obtained from an optical disk, which is performed in accordance with the apparatus of FIG. 6. At the beginning, the input signal is boosted to generate a boosted input signal (step S70). Next, the boosted input signal is detected to generate a binary signal (step S72). Next, the target levels for processing the input signal are dynamically adjusted according to the input signal and the binary signal (step S74). Next, the input signal is processed with the adjusted target levels to generate a processed signal (step S76). Next, the target levels for re-processing the input signal are dynamically adjusted according to the input signal and the processed signal (step S78). Next, the input signal is re-processed with the adjusted target levels obtained in step S78 to generate a Viterbi-processed data (step S80).

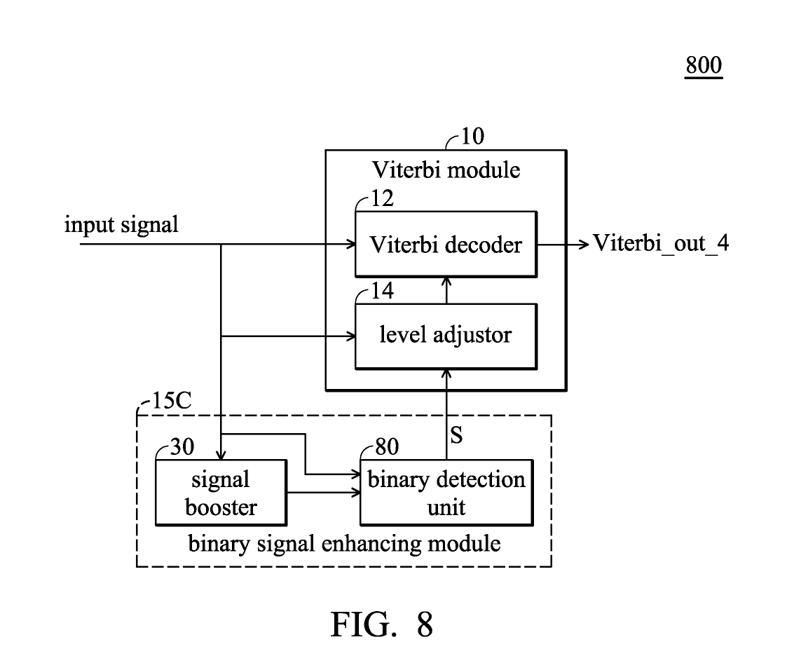

FIG. 8 depicts an apparatus for generating a Viterbi-processed data according to another embodiment of the invention. The apparatus 800 comprises a Viterbi module 10 and a binary signal enhancing module 15C, in which the binary signal enhancing module 15C comprises a signal booster 30 and a binary detection unit 80. The Viterbi module 10 further comprises a Viterbi decoder 12 and a level adjustor 14 as introduced in FIG. 2 above. In FIG. 8, the input signal is sent to the binary signal enhancing module 15C for signal boosting and generating a binary signal S according to the boosted signal. Specifically, the input signal is sent to the signal booster 30 for signal boosting. The signal booster 30 boosts the input signal and outputs a boosted input signal to the binary detection unit 80. The binary detection unit 80 generates the binary signal S for the level adjustor 14 based on the received input signal and boosted input signal. Based on the binary signal S and the input signal, the level adjustor 14 dynamically adjusts the target levels of the Viterbi decoder 12 such that the Viterbi decoder 12 processes the input signal using the adjusted target levels and outputs a Viterbi-processed data Viterbi_out_4. Note the Viterbi decoder 12 processing the input signal may refer to the decoding of the input signal, but is not limited thereto.

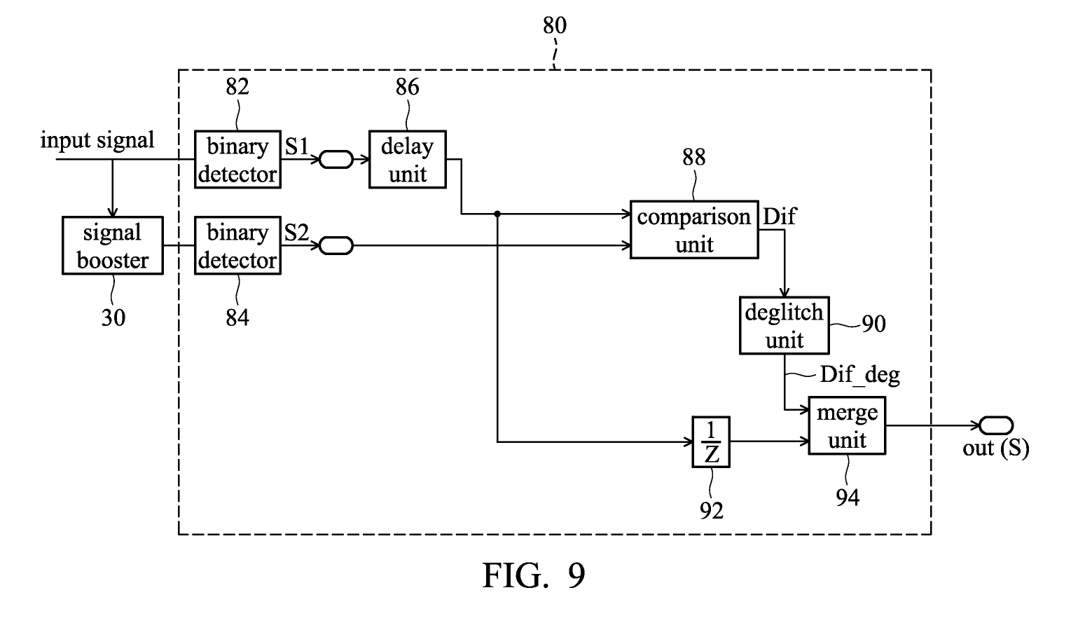

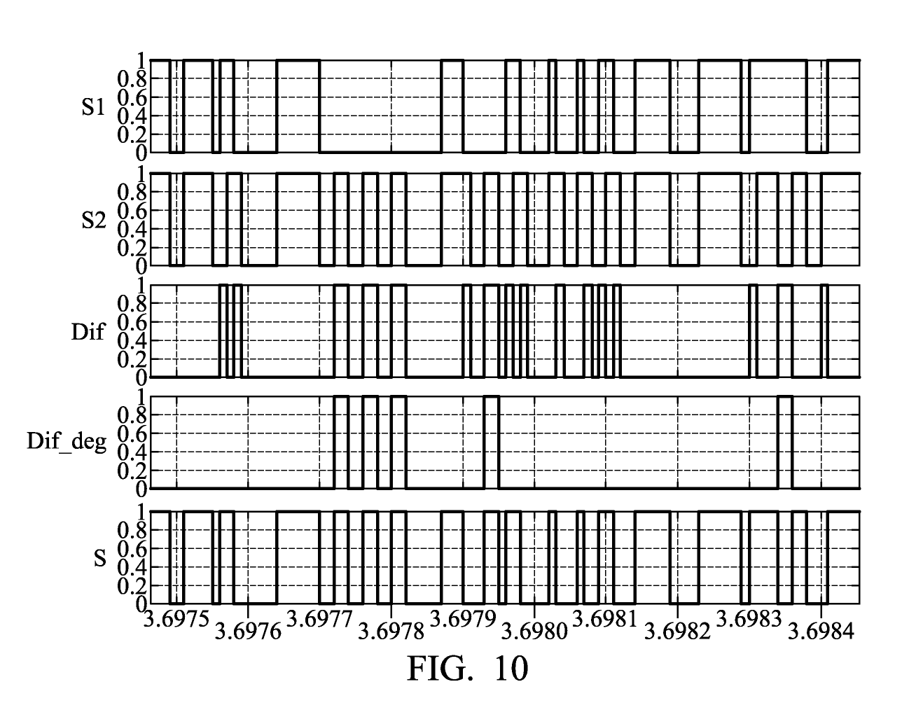

It is noted that before the input signal is processed by the Viterbi module 10, there may be a delay united (not shown) to delay the input signal. Thus, the delayed input signal's access timing and the binary signal S's access timing to the Viterbi module 10 maybe matched to each other. Moreover, in contrast to the embodiment of the FIG. 2, apart from the boosted input signal, the apparatus 800 in this embodiment additionally uses the input signal to perform the related operations in order to output the proper binary signal S for the Viterbi module 10, as elaborated in FIGS. 9 and 10 below.

FIG. 9 depicts a block diagram of a binary detection unit according to an embodiment of the invention. The binary detection unit 80 comprises a first binary detector 82, a second binary detector 84, a delay unit 86, a comparison unit 88, a deglitch unit 90, a gain unit 92 and a merge unit 94. The first binary detector 82 detects the input signal and outputs a first binary signal S1 as shown in FIG. 10. The second binary detector 84 detects the boosted input signal and outputs a second binary signal S2 as shown in FIG. 10. The first binary signal S1 is delayed by the delay unit 86 in order to synchronize with the second binary signal S2. The first binary signal S1, after being delayed, as well as the second binary signal S2, are sent to the comparison unit 88. The comparison unit 88 finds out the difference between the first binary signal S1 and the second binary signal S2, which may be implemented by an XOR gate. The XOR gate of the comparison unit 88 performs a XOR operation of the first binary signal S1 and the second binary signal S2 to find out the signal difference Dif therebetween, as shown in FIG. 10. The signal difference Dif is sent to the deglitch unit 90 which performs a deglitch operation on the signal difference Dif to generate a deglitched signal difference Dif_deg. The deglitch operation removes the logic-high portions of the signal difference Dif with period shorter than a predetermined time (typically, the predetermined time ‘1T’ is defined in the specification of optical disc drive), and generates the deglitched signal difference Dif_deg as can be seen in FIG. 10. The deglitched signal difference Dif_deg is then sent to the merge unit 94 which merges the deglitched signal difference Dif_deg back to the first binary signal S1 to generate the final binary signal S. The merge unit 94 may also be implemented by an XOR gate.

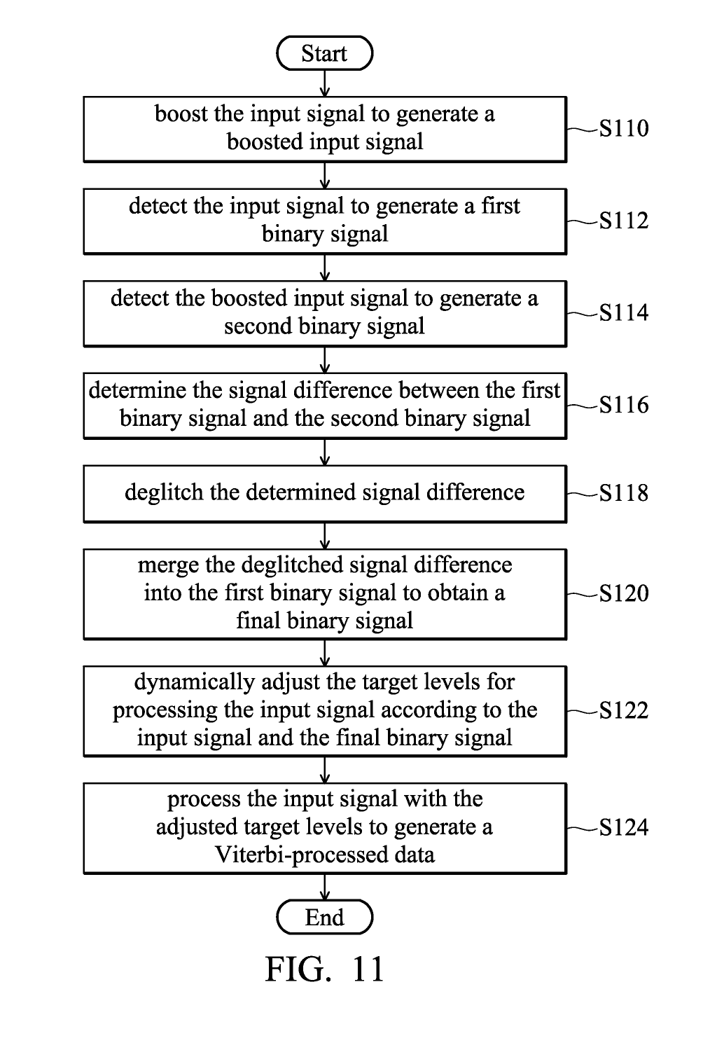

FIG. 11 depicts a flowchart of a method for generating a Viterbi-processed data using an input signal obtained from an optical disk, which is performed in accordance with the apparatus of FIGS. 8 and 9. At the beginning, the input signal is boosted to generate a boosted input signal (step S110). Next, the input signal is detected to generate a first binary signal (step S112). Next, the boosted input signal is detected to generate a second binary signal (step S114). Next, the signal difference between the first binary signal and the second binary signal is determined (step S116). Next, the determined signal difference is deglitched (step S118). Next, the deglitched signal difference is merged into the first binary signal to obtain a final binary signal (step S120). Next, the target levels for processing the input signal are dynamically adjusted according to the input signal and the binary signal (step S122). Next, the input signal is processed with the adjusted target levels to generate a Viterbi-processed data (step S124).

FIG. 12 depicts a detailed diagram of a level adjustor dynamically adjusting the target levels of a Viterbi decoder according to an embodiment of invention. Using the embodiment of FIG. 2 as an example, the level adjust 14 may comprise a pattern match unit 141 and a plurality of filters 142 (such as infinite impulse response filter, IIR). The pattern match unit 141 receives the binary signal and compares the binary signal with a plurality of default patterns, each corresponding to an individual filter 142. If the pattern of the binary signal matches one of the default patterns of the filters 142, the corresponding filter 142 will be enabled and the input signal is sampled by the filter 142. Based on this, a corresponding target level is outputted to the Viterbi decoder 12 for decoding.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for generating a Viterbi-processed data using an input signal obtained from an optical disk, comprising:
a Viterbi module configured to process the input signal and generate the Viterbi-processed data according to a binary signal; and
a binary signal enhancing module configured to boost the input signal and generate the binary signal accordingly.

2. The apparatus as claimed in claim 1, wherein the input signal is boosted by a FIR filter.

3. The apparatus as claimed in claim 1, wherein the Viterbi module comprises:
a Viterbi decoder configured to process the input signal according to at least one target level; and
a level adjustor configured to dynamically adjust the at least one target level according to the input signal and the binary signal.

4. The apparatus as claimed in claim 1, wherein the binary signal enhancing module comprises
a signal booster configured to boost the input signal to output a boosted input signal; and
a binary detector coupled to the Viterbi module and the signal booster, generating the binary signal by detecting the boosted input signal.

5. The apparatus as claimed in claim 1, wherein the input signal is obtained from an equalizer equalizing a radio frequency (RF) signal reproduced from the optical disk.

6. An apparatus for generating a Viterbi-processed data using an input signal obtained from an optical disk, comprising:
a first Viterbi module configured to process the input signal and generated the Viterbi-processed data according to a processed signal;
a second Viterbi module coupled to the first Viterbi module, processing the input signal according to a binary signal to output the processed signal; and
a binary signal enhancing module coupled to the second Viterbi module, generating the binary signal according to the input signal.

7. The apparatus as claimed in claim 6, wherein the binary signal enhancing module comprises:
a binary detector coupled to the Viterbi module, generating the binary signal by detecting the input signal.

8. The apparatus as claimed in claim 6, wherein the first Viterbi module comprises:
a first Viterbi decoder configured to process the input signal according to at least one first target level; and
a first level adjustor configured to dynamically adjust the at least one first target level according to the processed signal from the second Viterbi module.

9. The apparatus as claimed in claim 6, wherein the second Viterbi module comprises:
a second Viterbi decoder configured to process the input signal according to at least one second target level to output the processed signal; and
a second level adjustor configured to dynamically adjust the at least one second target level according to the binary signal.

10. The apparatus as claimed in claim 6, wherein the binary signal enhancing module further comprises a signal booster boosting the input signal to output a boosted input signal, wherein the binary detector generates the binary signal by detecting the boosted input signal.

11. The apparatus as claimed in claim 6, wherein the input signal is obtained from an equalizer equalizing a signal reproduced from the optical disk.

12. A method for generating a Viterbi-processed data using an input signal obtained from an optical disk, comprising the steps of:
boosting the input signal to output a boosted input signal;
generating a binary signal by detecting the boosted input signal; and
processing the input signal by a Viterbi module according to the binary signal input.

13. The method as claimed in claim 12, wherein the processing step comprises:
processing the input signal according to a processed signal, wherein the processed signal is generated according to the input signal and the binary signal.

14. The method as claimed in claim 13, wherein the step of processing the input signal according to a processed signal comprises:
processing the input signal according to at least one first target level; and
adjusting the at least one first target level dynamically according to the input signal and the processed signal.

15. The method as claimed in claim 13, wherein the step of processing the input signal according to the binary signal comprises:
processing the input signal according to at least one second target level; and
adjusting the at least one second target level dynamically according to the input signal and the binary signal.

16. The method as claimed in claim 12, wherein the input signal is obtained from an equalizer equalizing a radio frequency (RF) signal reproduced from the optical disk.

17. An apparatus for generating a Viterbi-processed data using an input signal obtained from an optical disk, comprising:
a Viterbi module configured to process the input signal according to a binary signal; and
a binary signal enhancing module configured to generate the binary signal according to the input signal.

18. The apparatus as claimed in claim 17, further comprising a delay unit to delay the input signal before the input signal is processed by the Viterbi module.

19. The apparatus as claimed in claim 17, wherein the binary signal enhancing module comprises:
a signal booster configured to boost the input signal to output a boosted input signal; and
a binary detection unit configured to detect the input signal and the boosted input signal to respectively generate the first binary signal and the second binary signal, find out the signal difference between the first binary signal and the second binary signal, and merge the signal difference into the first binary signal to generate the binary signal.

20. The apparatus as claimed in claim 19, wherein the binary detection unit comprises:
a first binary detector configured to detect the input signal to generate the first binary signal;
a second binary detector configured to detect the boosted input signal to generate the second binary signal;
a comparison unit configured to find out the signal difference between the first binary signal and the second binary signal; and
a merge unit configured to merge the signal difference into the first binary signal to generate the binary signal.

21. The apparatus as claimed in claim 17, wherein the Viterbi module comprises:
a Viterbi decoder configured to process the input signal according to at least one target level; and
a level adjustor configured to dynamically adjust the at least one target level according to the input signal and the binary signal.

22. The apparatus as claimed in claim 19, wherein the input signal is boosted by a FIR filter.

23. The apparatus as claimed in claim 20, wherein the comparison unit and the merge unit are an XOR gate.

24. The apparatus as claimed in claim 19, wherein the binary detection unit further comprises:
a deglitch unit configured to perform a deglitch operation on the signal difference before merging the signal difference into the first binary signal, thereby removing the portions of logic-high signal with period shorter than a predetermined time from the signal difference.

25. The apparatus as claimed in claim 17, wherein the input signal is obtained from an equalizer equalizing a radio frequency (RF) signal reproduced from the optical disk.
